(19) United States
(12) Patent Application Publication
(10) Pub. No.: US 2022/0180865 A1
(43) Pub. Date: Jun. 9, 2022

(54) RUNTIME TOPIC CHANGE ANALYSES IN SPOKEN DIALOG CONTEXTS

(71) Applicant: International Business Machines Corporation, Armonk, NY (US)

(72) Inventors: Shikhar Kwatra, San Jose, CA (US); Craig M. Trim, Ventura, CA (US); Sarbajit K. Rakshit, Kolkata (IN); Gregory J. Boss, Saginaw, MI (US)

(21) Appl. No.: 17/110,519

(22) Filed: Dec. 3, 2020

(51) Int. Cl. G10L 15/20; G10L 15/18

(52) U.S. Cl. CPC G10L 15/20; G10L 2015/227; G10L 15/1822

(57) ABSTRACT

Techniques for runtime topic change analyses in spoken dialog contexts and command execution include receiving a string of phrases associated with one or more users, parsing the string of phrases into a plurality of individual phrases, and determining a voice command from two or more of the plurality of individual phrases. The two or more plurality of individual phrases are non-contiguous in the string of phrases.

### BACKGROUND

The present invention generally relates to computer systems, and more specifically, to runtime topic change analyses in spoken dialog contexts.

Natural language processing (NLP) is concerned with the interactions between computers and human (natural) languages, particularly how to program computers to process and analyze natural language data. This natural language data can sometimes be questions, where the NLP system is used to answer the questions. An NLP system may build on search engine technology to provide a single answer to a question posed to it in natural language. The NLP system answers natural language questions by querying data repositories and applying elements of language processing, information retrieval, and machine learning to arrive at a conclusion.

### SUMMARY

Embodiments of the present invention are directed to runtime topic change analyses in spoken dialog contexts. A non-limiting example computer-implemented method includes receiving a string of phrases associated with one or more users, parsing the string of phrases into a plurality of individual phrases, and determining a voice command from two or more of the plurality of individual phrases. The two or more plurality of individual phrases are non-contiguous in the string of phrases.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of an example computer system for use in conjunction with one or more embodiments of the present invention;

FIG. 2 is a block diagram of a system for runtime topic change analyses in spoken dialog contexts and voice command execution in accordance with one or more embodiments of the present invention;

FIGS. 3A and 3B is a flowchart of a process for runtime topic change analyses in spoken dialog contexts and voice command execution in accordance with one or more embodiments of the present invention;

FIG. 4 is a flowchart of a method for runtime topic change analyses in spoken dialog contexts and vocalized command execution in accordance with one or more embodiments of the present invention;

FIG. 5 is a block diagram of identifying a voice command in phrases in accordance with one or more embodiments of the present invention;

FIG. 6 depicts a cloud computing environment according to one or more embodiments of the present invention; and

FIG. 7 depicts abstraction model layers according to one or more embodiments of the present invention.

### DETAILED DESCRIPTION

One or more embodiments of the present invention provide a system and method for runtime topic change analyses in spoken dialog contexts in order to determine a voice command. When a voice command is submitted having at least one interrupting phrase/spoken content, one or more embodiments of the invention can buffer a received voice command, remove the interruptions, and combine the remainder of the voice command with the earlier voice command to construct a complete voice command for execution.

Automatic speech recognition Intelligent Virtual Agents (IVA) are expected to grow at a significant rate, driven by the growing demand for smart devices in home automation systems. Intelligent home systems are increasingly being adopted and will continue to fuel the growth of IVAs to control smart home devices such as wireless thermostats, music systems, washing machines, and more. Current IVAs are limited to determining an intent from a fully iterated and spoken command. If the user wishes to look for an item, perform an activity, or control some device, it is necessary to vocalize the instruction set entirely and without interruption. For shorter imperatives such as “increase the volume”, “change the track”, “dim the lights”, etc., this is feasible. However, as IVAs grow more intelligent and increase, their capacity to understand multi-sentence input without interruption becomes more challenging. In a given household, where a variety of virtual assistants may exist for home automation or mobile device manipulation, distractions may be frequent because multiple users may be speaking in a conversation when one or more users are submitting a voice command. One or more embodiments of the invention provide a system and method for dynamic topic change analyses to determine a vocalized command. One or more embodiments of the invention permit a virtual assistant to handle complex vocalizations and differentiate vocalized commands from interruptions that occur within the same context of the voice command, such that the voice command can be deciphered from the interruptions.

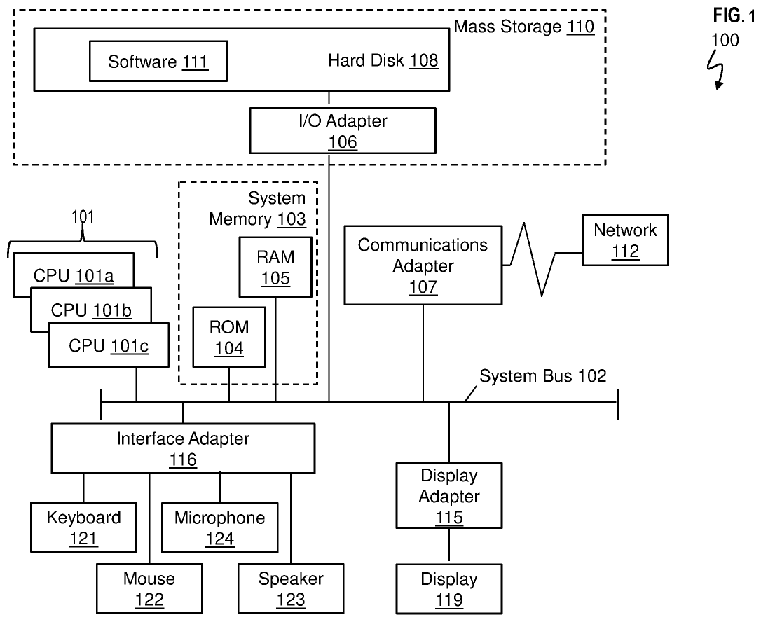

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, and, storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

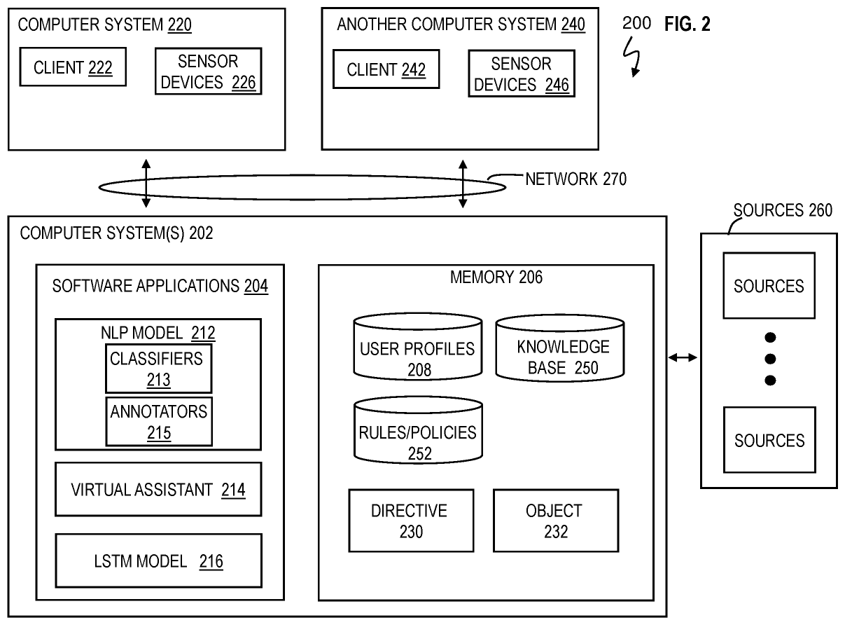

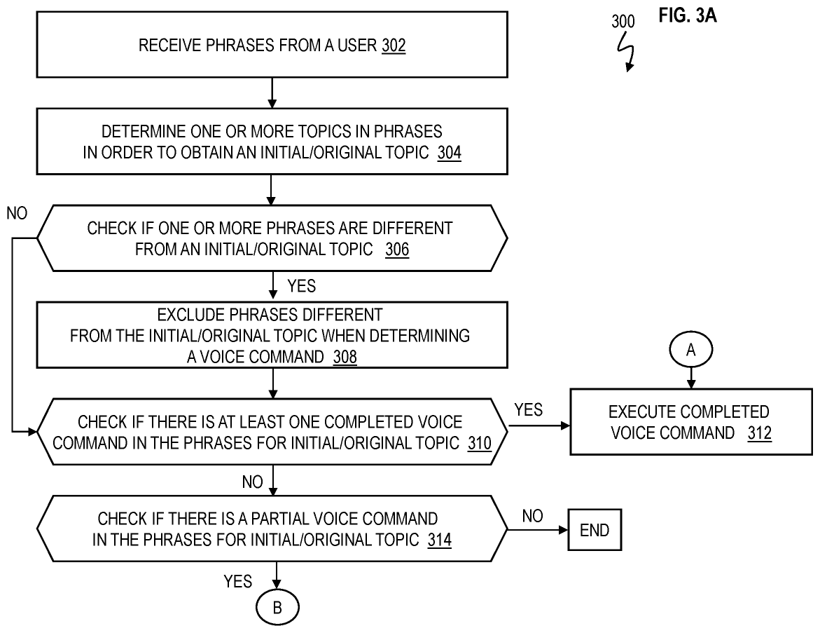

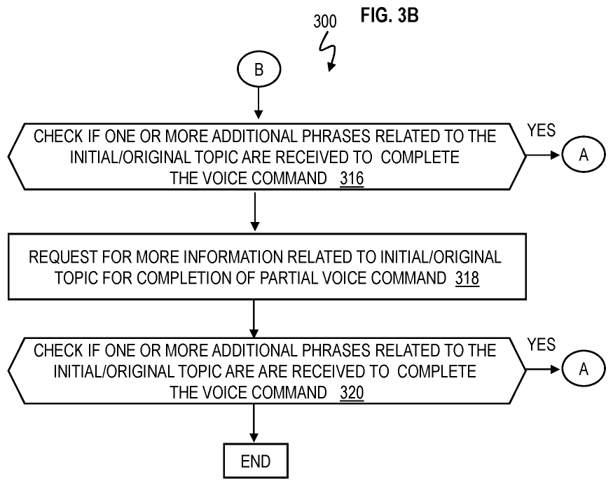

FIG. 2 is a block diagram of a system 200 for runtime topic change analyses in spoken dialog contexts and vocalized command execution in accordance with one or more embodiments of the present invention. FIG. 2 depicts one or more computer systems 202 coupled to computer system 220 and one or more other computer systems 240. Computer systems 220 and 240 can be representative of various devices having virtual assistant capabilities. Elements of computer system 100 may be used in and/or integrated into computer systems 202, computer system 220, and computer system 240. FIGS. 3A and 3B depict a flowchart of a process 300 for runtime topic change analyses in spoken dialog contexts and vocalized command execution in accordance with one or more embodiments of the present invention. Process 300 in FIGS. 3A and 3B will be described below with reference to FIGS. 2, 3A, and 3B.

At block 302 of process 300, software applications 204 on computer system 202 is configured to obtain (e.g., listen for and/or receive) phrases from a user via computer system 220. Software applications 204 may be implemented as software 111 executed on one or more processors 101. One or more sensor devices 226 of computer system 220, along with sensors devices 246 of computer system 240, are configured to capture phrases spoken by the user. Sensor devices 226 can include microphones, cameras, etc., configured to capture phrases spoken by the user. Client application 222 is configured to push over network 270 the captured phrases to computer system 202 for processing. Client application 222 can be a thin software application, plug in, firmware, etc., configured to extract spoken phrases (words, etc.) on computer system 220 and send to computer system 202. Client application 222 may be implemented using software 111 configured to execute on one or more processors 101, as discussed in FIG. 1. Analogous functionality applies to client application 242 operating on computer system 240.

Software applications 204 may utilize various types of speech analysis techniques to determine if the phrases are spoken by more than one speaker, how many speakers are speaking, the identity of the speakers, etc. For example, software applications 204 may utilize mel-frequency cepstrum coefficients (MFCC) and/or be coupled to MFCC algorithms for audio extraction for conversation monitoring, speech recognition, and speech correction, thereby being able to determine the identity and/or identities of one or more speakers and/or a change from one speaker to another speaker. Accordingly, software applications 204 can determine if more than one person is speaking. Software applications 204 can also receive, request, and/or check for video captured related to the received phrases and/or the timestamp of the received phrases. Software applications 204 can use the video associated with the received phrases to identify which speakers have spoken the phrases. Using suitable sensors of sensors devices 226 and 246, the video could be captured by computer system 220 and 240, respectively. Software applications 204 can use identity recognition algorithms along with speech recognition algorithms to match various speakers with their spoken phrases and/or at least distinguish that different speakers are speaking. Software applications 204 can store speech features and identity recognition features for respective users in user profiles database 208.

Referring to FIG. 3A, at block 304, software applications 204 on computer system 202 are configured to determine one or more topics in phrases associated with the user and received from computer system 220. Topic analysis is a natural language processing (NLP) technique that allows software applications 204 to automatically extract meaning from texts by identifying recurrent themes or topics. Software applications 204 may analyze text and/or audio versions of the phrases. Software applications 204 can use and/or employ speech-to-test software for converting the verbal/audio phrases to text. Software applications 204 can employ various natural language processing techniques to determine the one or more topics present in the received phrases. Software applications 204 can be integrated with and/or employ a natural language processing (NLP) model 212 to determine a topic. Software applications 204 and/or NLP model 212 can perform semantic and synaptic content analysis via a tone analyzer and keyword extraction to determine a topic in the phrases. Software applications 204 and/or NLP model 212 can use various algorithms to determine topics. Two example approaches for topic analysis with machine learning are NLP topic modeling and NLP topic classification, either or both of which can be employed by NLP model 212. Topic modeling is an unsupervised machine learning technique. This means it can infer patterns and cluster similar expressions without needing to define topic tags or train data beforehand. Text classification or topic extraction from text, on the other hand, needs to know the topics of a text before starting the analysis, because the operator needs to tag data in order to train a topic classifier.

Software applications 204 and/or NLP model 212 can determine an initial/original topic of the topics, and the initial/original topic may be the first part of voice command according to a temporal or chronological order of the phrases. The spoken phrases received from computer system 220 by computer system 202 may be considered an NLP request, which can be a question or query made by the user of computer system 220 via client application 222. The NLP request can be a verbal query, for example, spoken in natural language using a microphone of computer system 220. In one or more embodiments, software applications 204 have an application programming interface (API) that can interact with and/or call the NLP model 212 to process the NLP request. Natural language processing via NLP model 212 returns insights particularly topics from the unstructured text of phrases to distinguish phrases of a voice command related to the initial/original topic from phrases that are interruptions related to different topics. NLP model 212 can access a dictionary of terms and language rules, for example, in knowledge base 250 and rules/policies database in memory 206. In addition, NLP model 212 can include deep learning contextual annotators 215 that extract more insight into the concept in the context of the text.

Referring to FIG. 3A, at block 306, software applications 204 (e.g., employing NLP model 212) are configured to check if one or more phrases contain a topic different from the initial/original topic related to the voice command spoken by the user. If there are no other topics (“NO”), flow proceeds to block 310. If there are other topics (“YES”), at block 308, software applications 204 (e.g., employing NLP model 212) are configured to exclude any phrases containing topics different from and/or unrelated to the initial/original topic when determining/analyzing the voice command related to the initial/original topic. After analyzing the phrases related to the initial/original topic, software applications 204 are configured to check if there is at least one completed voice command related to the initial/original topic at block 310, and if (“YES”) the completed voice command is determined to be present, software applications 204 are configured to execute the completed voice command related to the initial/original topic at block 312. If no completed voice command is present (“NO”), software applications 204 are configured to check if there is a partial voice command in the phrases for the initial/original topic at block 314. If no partial voice command is present (“NO”), the flow ends.

Software applications 204 may include, be integrated with, and/or employ an intelligent virtual assistant (IVA) or intelligent personal assistant (IPA), such as for example, virtual assistant 214, which is a software agent that can perform tasks or services for an individual based on commands or questions. Virtual assistant 214 can interpret human speech and respond via synthesized voices. Virtual assistant 214 can use natural language processing and may be integrated with and/or employ NLP model 212 for NLP processing. Software applications 204 use NLP processing to match the phrases associated with the initial/original topic of user text or voice input to executable commands.

To cause a voice command in received phrases to be executed by virtual assistant 214 of software applications 204, the voice command usually includes one or more terms determined to be, for example, a directive 230 and one or more terms determined to be, for example, an object 232 of the directive 230. In the voice command, the directive could be the desired action to be taken, while the object may be that upon which the action occurs or could be additional details utilized to complete the action. In some cases, a wakeup word may be utilized via client application 222 to activate or wake up the computer system 220, as understood by one skilled in the art. The directive 230 and object 232, which may be used to form a complete a voice command, usually follow the wakeup word such that the computer system 220 is active. In some voice commands, the object 232 may be understood and can be implied from the directive 230 without requiring the object 232 to be spoken. For example, when music is playing from computer system 220, the word “stop” can be the directive 230 to discontinue music currently being played from computer system 220 without requiring vocalization of an object 232 of the directive like “playing music”. Most virtual assistants understand that “stop” means “stop playing music” when music is currently playing. The explanation of having a voice command that generally includes a directive and object is for explanation purposes and not limitation. Voice commands can be made in any form that is understood by the virtual assistant, for example, using software applications 204. In some cases, the directive can be an inquiry. A partial voice command may include one or more terms that software applications 204 (e.g., virtual assistant 214) determine to be and/or identify as the directive 230 without the remainder such as the object 232 (or vice versa), thereby providing an incomplete voice command such that software applications 204 require additional information to execute the partial voice command. Additionally, regardless of whether the example directive and object structure is used, the partial voice command is understood to be incomplete and thus additional information is expected to complete the voice command. Accordingly, when a partial voice command is determined to be present in the phrases related to the initial/original topic, software applications 204 are configured to wait for additional information related to the initial/original topic that can complete the partial voice command.

Referring to FIG. 3B, at block 316, software applications 204 are configured to check after a predetermined time if one or more additional phrases related to the initial/original topic are (subsequently) received to complete the partial voice command. When additional phrases are received to complete the partial voice command, software applications 204 are configured to execute the completed voice command at block 312. For example, the directive 230 could have been received earlier in time as part of the phrases related to the initial/original topic, and software applications 204 determine that the additional phrases received later in time contain the object 232 (for the initial/original topic) for the directive 230, such that the partial voice command is now complete and ready for execution. Between receiving the directive 230 and the object 232 for the voice command, there can be various phrases (and/or spoken content) for other topics unrelated to phrases of the initial/original topic. Software applications 204 determine that vocalization of these phrases for other topics not related to the initial/original topic are interruptions to the voice command which occur within the same context or time period of the voice command, but these interruptions are not part of the voice command.

At block 318, when additional phrases for the initial/original topic are not received to complete the partial voice command, software applications 204 are configured to request for additional information related to the initial/original topic for completion of the partial voice command. At block 320, responsive to the request, software applications 204 are configured to check if additional phrases related to the initial/original topic are received to complete the partial voice command. If so (“YES”), flow proceeds to block 312. Otherwise (“NO”), the process 300 ends.

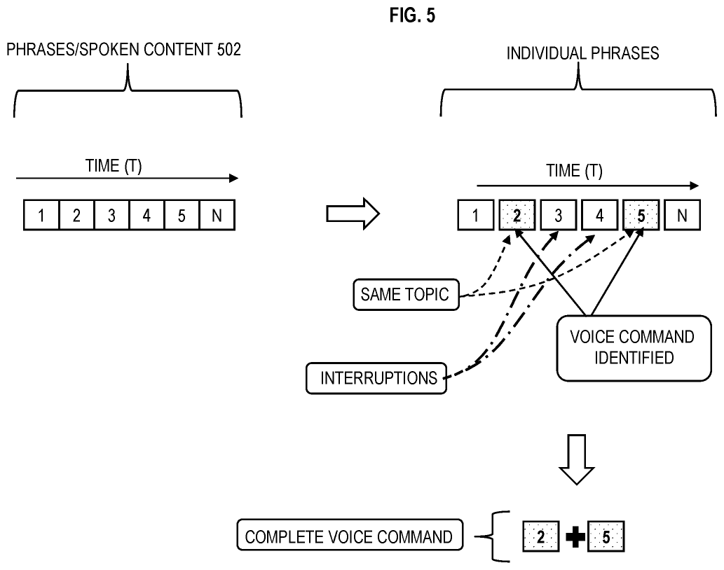

FIG. 5 is a block diagram of an example processing for phrases/spoken content in accordance with one or more embodiments of the invention. A string of phrases/spoken content 502 are received over time (T) by software application 204. The individual phrases are processed as discussed here to determine their topics. Software applications 204 perform topic analysis and determine that phrase/spoken content 2 is a partial voice command, while the immediate subsequent phrases/spoken content 3 and 4 are a different topic from the partial voice command and are not part of the voice command. Phrases/spoken content 3 and 4 are identified as interruptions to the voice command. Software applications 204 determine that phrase/spoken content 5 is the same topic as earlier phrase/spoken content 2 and thereby identify the combination of phrases/spoken content 2 and 5 as the complete voice command. Accordingly, software applications 204 execute and/or cause the execution of the complete voice command.

In one or embodiments of the invention, NLP model 212 can include one or more classifiers 213 (described in more detail below). In one or more embodiments of the invention, the features of the various classifiers 213 (or engines) described herein can be implemented on the processing system 100 shown in FIG. 1 or can be implemented on a neural network (not shown). In one or more embodiments of the invention, the features of the classifiers 213 can be implemented by configuring and arranging the processing system 100 to execute machine learning (ML) algorithms. In general, ML algorithms, in effect, extract features from received data (e.g., spoken content including phrases from computer system 220) in order to “classify” the received data. Examples of suitable classifiers include but are not limited to neural networks (described in greater detail below), support vector machines (SVMs), logistic regression, decision trees, hidden Markov Models (HMIs), etc. The end result of the classifier's operations, i.e., the “classification,” is to predict a class for the data. The ML algorithms apply machine learning techniques to the received data in order to, over time, create/train/update a unique “model.” The learning or training performed by the classifiers 213 (engines) can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In one or more embodiments of the invention where the classifiers 213 (engines) are implemented as neural networks, a resistive switching device (RSD) can be used as a connection (synapse) between a pre-neuron and a post-neuron, thus representing the connection weight in the form of device resistance. Neuromorphic systems are interconnected processor elements that act as simulated “neurons” and exchange “messages” between each other in the form of electronic signals. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. For example, a neuromorphic/neural network for handwriting recognition is defined by a set of input neurons, which can be activated by the pixels of an input image. After being weighted and transformed by a function determined by the network's designer, the activations of these input neurons are then passed to other downstream neurons, which are often referred to as “hidden” neurons. This process is repeated until an output neuron is activated. Thus, the activated output neuron determines (or “learns”) which character was read. Multiple pre-neurons and post-neurons can be connected through an array of RSD, which naturally expresses a fully-connected neural network. In the descriptions here, any functionality ascribed to the system 200 can be implemented using the processing system 100.

The classifiers 213 can perform natural language processing (NLP) analysis techniques on the sets of passages/phrases which are composed of natural language text. NLP is utilized to derive meaning from natural language. The classifiers 213 can analyze the set of passages/phrases by parsing, syntactical analysis, morphological analysis, and other processes including statistical modeling and statistical analysis. The type of NLP analysis can vary by language and other considerations. The NLP analysis is utilized to generate a first set of NLP structures and/or features which can be utilized by the classifiers 213 to determine congruency between words and phrases in a passage. These NLP structures include a translation and/or interpretation of the natural language input, including synonymous variants thereof. The classifiers 213 can analyze the features to determine a context for the features. NLP analysis can be utilized to extract attributes (features) from the natural language. These extracted attributes can be analyzed by the classifiers 213 to determine a congruency score and compare this score to a pre-defined threshold to determine whether to generate a relation annotation for the passage being analyzed.

Various example scenarios are discussed below for explanation purposes and ease of understanding but not limitation. In this example scenario, Users A, B, C, D are in a conversation as illustrated below.

a. User A: “How about your next travel plan?”

b. User B: “This time I am planning to travel to X city.”

c. User C: “Now I need to leave, let me find a route.” [Now User C is speaking out the voice command.]

d. User C: “Hey Google® system, give me directions.” [User D enters the room. Accordingly, User C is greeting user D while submitting voice command.]

e. User C: “Hello User D.”

f. User D: “Hi User C.” [After greeting, User C is speaking out the remaining part of the voice command.]

g. User C: “between locations A and B”.

In this example scenario, it can be observed that User C is submitting the voice command, but there is an interruption, as User C greets User D, so the voice command is submitted in an informal manner (i.e., with an interruption). Here, the complete voice command is composed of the statements in “d” plus “g”. However, in this case, the spoken content “e” and “f” are not part of the voice command, and the statements in “e” and “f” are an interruption in the voice command. The complete voice command is “Hey Google® system, give me directions between locations A and B.” As discussed herein, the example conversation may be captured by one or more microphones coupled to computer system 220, and the conversation is pushed to software applications 204 on computer systems 202 for processing in accordance with one or more embodiments of the invention.

Software applications 204 are configured to perform command buffering using, for example, a long short term memory (LSTM) model 216 with cosine similarity for determining similarity or sameness among the topics (e.g., to determine similar topics and/or dissimilar topics) of the spoken content based on the topics classified by NLP model 212. LSTM model 216 can be an artificial recurrent neural network (RNN) architecture. In accordance with one or more embodiments, LSTM networks are used for classifying, processing, and making predictions based on time series data, since there can be lags of unknown duration between important events in a time series such as the time between a partial voice command and the residual voice command. For example, the time between phrase/spoken content 2 and phrase/spoken content 5.

Software applications 204 are configured to capture User C voice command using, for example, MFCC which is buffered in LSTM for a certain temporal period “T” while waiting for additional spoken content (i.e., phrases) of a similar context to thereby make a complete voice command that can be executed. Software applications 204 can use one or more clustering algorithms (e.g., as part of NLP model 212) to identify the category or topic of spoken content “d” as a partial topical analysis in order to (later) gather the residual voice command after the interruption by spoken content “e” and “f”. In one or more embodiments, the clustering algorithms can use k-means clustering to categorize/cluster the topics in the example scenario and thereby determine/recognize that spoken content “d” and “g” belong together to form a complete voice command that can be executed. Accordingly, software applications 204 using, for example, virtual assistant 214 execute the completed voice command. In some instances, software applications 204 may have to communicate with one or more sources 260 to execute the command, for example, to search and return an answer, to perform a service, to place an order, etc. Sources 260 can be representative of numerous servers and computer systems which provide services including social networking services, social media services, email services, professional services, and other services including control of various appliances, cameras, home automated systems, etc., over a network like the Internet.

As discussed herein, when a new voice command is submitted (to computer system 202) having at least one interrupting phrase/spoken content, software applications 204 are configured to remove the one or more interruptions related to different topics from the voice command having the initial/original topic (as discussed above), buffer the previous voice command which is a partial voice command, receive and determine the remainder of the voice command related to the initial/original topic, and execute the now complete voice command. To aid in the analysis, software applications 204 may construct conversation segments from a multi-user conversation by performing the following. Software applications 204 are configured to identify new voice types mid-conversation using, for example, MFCC algorithms, identify pauses in the conversation which indicate a change in user, identify key interruption phrases (such as, e.g., “excuse me”, “hold on a second”, “no, wait”, etc.) in order to distinguish and eliminate interruptions, and identify conversations that in whole do not follow proper grammatical construction which may further be indicative of an interruption. Key interruption phrases can be stored in knowledge base 250 and accessed during NLP processing. Once conversation segments such as spoken content or phrases are identified, software applications 204 can augment any existing method described herein by analyzing combinations of the segments and then scoring each derivative with a confidence score according to how likely a candidate voice command matches the context and user. Each derivative that contains a voice command with high confidence of being relevant is given consideration.

An example cohort command scenario is provided below. In this example scenario, User A wishes to order either coffee or tea for User B. Hence, while ordering (submitting voice command), User A is also asking for input from User B as depicted in the following.

User A: Alexa ® system, “Order one cup of . . . ” (by looking at user B and pausing).

User B: “Tea for me please.”

Hence, software applications 204 are configured to consider and construct a complete voice command as “Alexa® system, Order one cup of Tea.” As seen in the example scenario, if two or more people (e.g., Users A and B) participate together to complete a voice command, then software applications 204 are configured to recognize each partial voice command using MFCC feature extraction (e.g., using conversation monitoring and feature matching) and using contextual situation analysis from every participant. Software applications 204 are configured to form a logical construct of a complete voice command to execute. Although Users A and B can be identified by software applications 204 as two different people because of two different voice patterns (via MFCC), software applications 204 are configured to use NLP processing (e.g., via NLP model 212) to determine that the initial/original topic in the spoken phrase of User A matches/coincides with the topic in the spoken phrase by User B. Software applications 204 are configured to determine that the spoken phrase of User A is a partial voice command (e.g., having a directive 230) and the spoken phrase of User B is the remainder voice command (e.g., object 232) needed to construct a complete voice command.

In one or more embodiments, software applications 204 can have user defined rules/policies database 252 for how to resolve ambiguity in voice commands. As part of the rules/policy configuration for reinforcement training, if there is any ambiguity in receiving a voice command from an informal conversation, then software applications 204 are configured to construct possible combinations of voice commands from the conversation, arrange/order the most likely voice commands, and present the ordered listing of voice commands to the user (e.g., by causing audio to play from computer system 220) for confirmation before execution. As such, software applications 204 understand (via topic analysis) which conversation segments or phrases are not related to a voice command and accordingly eliminate these as interruptions. For example, during any conversation, several topics could be discussed. However, all conversation segments are not intended to be taken as a voice command. Hence, based on the user's behavior and interaction (which are continually stored in rules/policies database 252 and/or user provides 208) with software applications 204 and other people in the vicinity, software applications 204 determine which conversation segments need to be considered as a valid executable voice command and which are interruptions.

Another example scenario is provided below which illustrates further details for runtime topic change analyses in spoken dialog contexts and vocalized command execution. The following example scenario illustrates multiple people engaged in a conversation. Software applications 204 are configured to identify which conversation segments are interruptions in order to target the voice command. Accordingly, software applications 204 identify the snippet or portion (e.g., phrase) of the conversation segment that needs to be removed or neglected from the voice command. The example scenario is the following.

#1) User C: “Tell me the route.”

#2) User C: “Hello User D.”

#3) User D: “Hi User C.”

#4) User C: “between locations A and B.”

Software applications 204 are configured to construct the complete voice command in spoken content #1) and #4) by identifying and removing interrupting spoken content #3). For a conversation with multiple speakers and one or more interruptions, software applications 204 are configured to perform pattern analysis which includes gathering historical voice commands from different users along with different types of interruption. This gathered data can be stored and accessed in knowledge base 250. Conversation monitoring and gathering data from sensor feeds, such as sensors devices 226 and 246 can also occur. After having analyzed and stored a previous pattern, software applications 204 (e.g., using NLP model 212) are configured to identify a similar pattern in the future, thereby recognizing interruptions and voice commands in phrases.

Software applications 204 are configured to perform contextual situation analysis of the voice command. Software applications 204 identify any discontinuity in the spoken voice command. For example, “Hey Google® system, give me directions”, “Hello User D”, “between locations A and B.” Software applications 204 identify “Hello User D” as a discontinuity in the complete voice command “Hey Google® system, give me directions between locations A and B.” Software applications 204 are configured to perform iterative feedback learning. As noted above, if software applications 204 are unable to understand the voice command, software applications 204 may return an incorrect response where the user will have an opportunity to rectify the voice response while software applications 204 is in buffered mode. To help software applications 204 (via NLP model 212) learn the complete voice command when interrupted, software applications 204 are configured to perform contextual command comparison which compares the interrupted voice command to an uninterrupted voice command. Software applications 204 then identifies the conversation segments which are not part of the actual voice command. For instance, the user may correct or clarify the voice command to software applications as “give me directions between locations A and B.” Accordingly, software applications 204 are configured to identify the conversation segment that caused the interruption as “Hello User D”. The conversation segment that caused the interruption from the same user and/or from multiple users is gathered historically in knowledge base 250 and used in the learning technique for NLP model 212. As such, software applications 204 are configured to identify the pattern of the conversation segment that caused the interruption to the voice command. For example, the pattern may indicate the condition that caused the interruption as well as the related conversation segments that contributed to the interruption. As part of corpus creation, software applications 204 create a knowledge corpus, such as knowledge base 250, to identify the pattern of interrupted conversation segments in the collected voice commands. When any new voice command is submitted, software applications 204 can reference knowledge base 250 to identify any possible interrupted conversation segments in the voice command, and accordingly software applications 204 exclude the interrupted segment such that the complete voice command formed for execution.

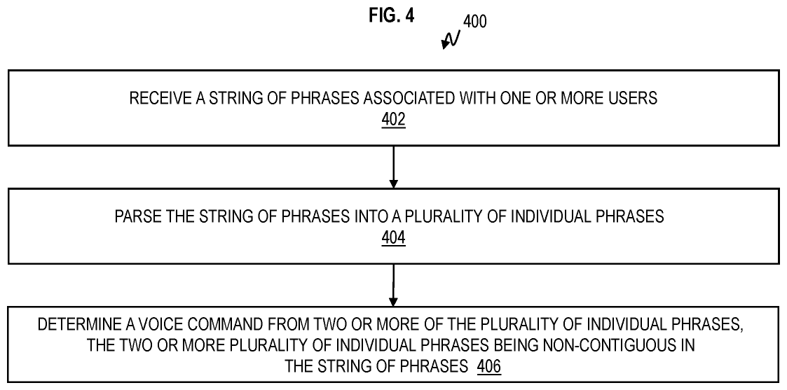

FIG. 4 depicts a flowchart of a method 400 for runtime topic change analyses in spoken dialog contexts and vocalized command execution in accordance with one or more embodiments of the invention. Software applications 204 are configured to receive a string of phrases (e.g., phrases 502 depicted in FIG. 5) associated with one or more users/speakers at block 402, parse the string of phrases into a plurality of individual phrases (e.g., phrase 1, phrases 2, phrase3, through phrase N, where N is the last phrase illustrated in FIG. 5) at block 404, and determine a voice command from two or more of the plurality of individual phrases (e.g., phrase/spoken content 2 and phrase/spoken content 5 illustrated in FIG. 5), the two or more plurality of individual phrases being non-contiguous in the string of phrases at block 406. Non-contiguous refers to being separated by one or more phrases/spoken content not related to phrases forming the voice command. Non-contiguous refers to interrupting phrases/spoken content having a topic different from the phrases/spoken content forming a complete voice command. For example, phrases/spoken content 2 and 5 are separated in time (T) from one another by interrupting phrases/spoken content 3 and 4 in FIG. 5; therefore, phrases/spoken content 2 and 5 are non-contiguous.

The string of phrases relates to spoken content. One or more of the plurality of individual phrases are received at different times. For example, phrase/spoken content 2 can be received earlier in time (T) than phrase/spoken content 5. Determining the voice command from the two or more of the plurality of individual phrases comprises determining that the two or more of the plurality of individual phrases are associated with an identified topic (i.e., the same topic in FIG. 5). Determining the voice command from the two or more of the plurality of individual phrases comprises identifying one or more interruptions (e.g., phrases/spoken content 3 and 4 as interruptions in FIG. 5) between the two or more of the plurality of individual phrases and determining that the voice command includes the two or more of the plurality of individual phrases excluding the one or more interruptions. Software applications 204 are configured to activate one or more devices (e.g., sensor devices 226 and 246 of computer systems 220 and 240, respectively) and/or cause one or more devices to be activated to obtain additional information to determine the voice command responsive to a threshold for further clarity not being met. Software applications 204 are configured to request confirmation of the voice command that has been determined. For example, software applications 204 can have a threshold for clarity and/or a confidence level that should be met for a determined voice command; if not met, further information can be requested and/or one or more devices can be activated to gain additional contextual information.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

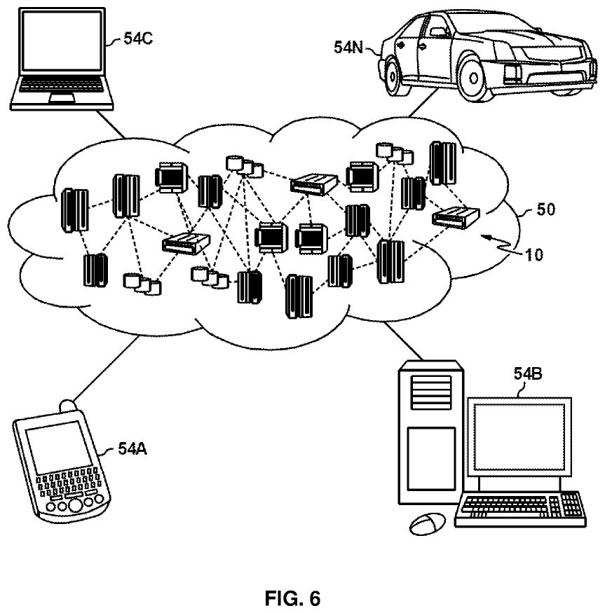

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

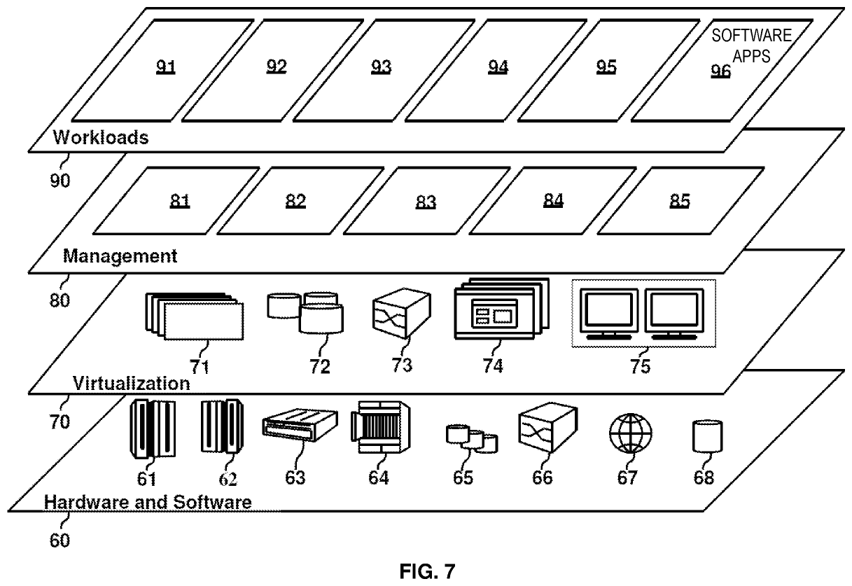

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and software applications (e.g., software applications 204, NLP model 212, virtual assistant 214, LSTM model 216, etc.) implemented in workloads and functions 96. Also, the software applications can function with and/or be integrated with Resource provisioning 81.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a string of phrases associated with one or more users;
parsing the string of phrases into a plurality of individual phrases; and
determining a voice command from two or more of the plurality of individual phrases, the two or more plurality of individual phrases being non-contiguous in the string of phrases.

2. The computer-implemented method of claim 1, wherein the string of phrases relates to spoken content.

3. The computer-implemented method of claim 1, wherein one or more of the plurality of individual phrases are received at different times.

4. The computer-implemented method of claim 1, wherein determining the voice command from the two or more of the plurality of individual phrases comprises determining that the two or more of the plurality of individual phrases are associated with an identified topic.

5. The computer-implemented method of claim 1, wherein determining the voice command from the two or more of the plurality of individual phrases comprises identifying one or more interruptions between the two or more of the plurality of individual phrases and determining that the voice command includes the two or more of the plurality of individual phrases excluding the one or more interruptions.

6. The computer-implemented method of claim 1, further comprising activating one or more devices to obtain additional information to determine the voice command responsive to a threshold for further clarity not being met.

7. The computer-implemented method of claim 1, further comprising requesting confirmation of the voice command that has been determined.

8. A system comprising:
a memory having computer readable instructions; and
one or more processors for executing the computer readable instructions, the computer readable instructions controlling the one or more processors to perform operations comprising:
receiving a string of phrases associated with one or more users;
parsing the string of phrases into a plurality of individual phrases; and
determining a voice command from two or more of the plurality of individual phrases, the two or more plurality of individual phrases being non-contiguous in the string of phrases.

9. The system of claim 8, wherein the string of phrases relates to spoken content.

10. The system of claim 8, wherein one or more of the plurality of individual phrases are received at different times.

11. The system of claim 8, wherein determining the voice command from the two or more of the plurality of individual phrases comprises determining that the two or more of the plurality of individual phrases are associated with an identified topic.

12. The system of claim 8, wherein determining the voice command from the two or more of the plurality of individual phrases comprises identifying one or more interruptions between the two or more of the plurality of individual phrases and determining that the voice command includes the two or more of the plurality of individual phrases excluding the one or more interruptions.

13. The system of claim 8, further comprising activating one or more devices to obtain additional information to determine the voice command responsive to a threshold for further clarity not being met.

14. The system of claim 8, further comprising requesting confirmation of the voice command that has been determined.

15. A computer program product comprising a computer readable storage medium having program instructions embodied therewith, the program instructions executable by a processor to cause the processor to perform operations comprising:
receiving a string of phrases associated with one or more users;
parsing the string of phrases into a plurality of individual phrases; and
determining a voice command from two or more of the plurality of individual phrases, the two or more plurality of individual phrases being non-contiguous in the string of phrases.

16. The computer program product of claim 15, wherein the string of phrases relates to spoken content.

17. The computer program product of claim 15, wherein one or more of the plurality of individual phrases are received at different times.

18. The computer program product of claim 15, wherein determining the voice command from the two or more of the plurality of individual phrases comprises determining that the two or more of the plurality of individual phrases are associated with an identified topic.

19. The computer program product of claim 15, wherein determining the voice command from the two or more of the plurality of individual phrases comprises identifying one or more interruptions between the two or more of the plurality of individual phrases and determining that the voice command includes the two or more of the plurality of individual phrases excluding the one or more interruptions.

20. The computer program product of claim 15, further comprising activating one or more devices to obtain additional information to determine the voice command responsive to a threshold for further clarity not being met.
